(19) United States
(12) Patent Application Publication
(10) Pub. No.: US 2014/0055262 A1
(43) Pub. Date: Feb. 27, 2014

(54) NeverLoseIt: System to Alert Users When They Are About To Misplace An Item

(71) Applicant: Edward Luis Cavalcanti, Washington, DC (US)

(72) Inventor: Edward Luis Cavalcanti, Washington, DC (US)

(21) Appl. No.: 13/803,171

(22) Filed: Mar. 14, 2013

Related U.S. Application Data
(60) Provisional application No. 61/691,285, filed on Aug. 21, 2012.

(51) Int. Cl. G08B 21/24

(52) U.S. Cl. CPC G08B 21/24
USPC 340/539.13

(57) ABSTRACT

The present invention relates to the tracking of a user's personal belongings, in particular, to systems and methods utilizing radio-frequency identification (RFID) tags to track one or more personal belongings associated with a mobile device with a RFID reader. The systems and methods detect whether registered RFID-tagged personal belongings are within or outside a range in proximity to the mobile device. And, upon detecting one or more registered RFID-tagged personal belongings outside the range, the systems and methods alert the user to prevent the loss or misplacement of the user's personal belongings.

### CROSS REFERENCE TO RELATED APPLICATIONS

This application claims the benefit of priority to and incorporates herein by this reference in its entirety, U.S. Provisional Patent Application No. 61/691,285, entitled “NeverLoseIT-System to Alert Users When They Are About to Misplace an Item” and filed on Aug. 21, 2012.

### BACKGROUND OF THE INVENTION

Radio-frequency identification (RFID) technology utilizes tags attached to an object to be identified and/or tracked, each tag transfers data that may be read up to several yards away. Various RFID tags do not require battery power and can be read at short distances via magnetic fields produced through electromagnetic induction. RFID tags may be embedded in the object to be tracked.

Currently, RFID tags have been utilized in numerous fields, including industries for tracking products in an assembly line or other inventory applications. RFID tags also have been used to track and identify livestock and pets.

In addition, RFID technology has been implemented on mobile devices to provide read/write and contactless payment capabilities. RFID readers associated with a mobile device can write and read the information on a RFID tag. Accordingly, the RFID readers can be configured as credit, debit, pre-paid and loyalty cards, for secure contactless transactions.

It is a common problem for people to misplace, lose, or leave behind personal belongings, including valuables such as keys, purses, glasses, etc. This problem has grown with the increasing number of personal belongings being carried by people today. Accordingly, there is a need to provide a simple and convenient mechanism to warn a person before his/her valuables are misplaced.

### SUMMARY OF THE INVENTION

The present invention relates to the tracking of a user's personal belongings, in particular, to systems and methods utilizing radio-frequency identification (RFID) tags to track one or more personal belongings associated with a mobile device with a RFID reader. The systems and methods detect whether registered RFID-tagged personal belongings are within or outside a range in proximity to the mobile device. And, upon detecting one or more registered RFID-tagged personal belongings outside the range, the systems and methods alert the user to prevent the loss or misplacement of the user's personal belongings.

### BRIEF DESCRIPTION OF THE DRAWINGS

FIG. 1 illustrates an exemplary embodiment of a mobile device with a RFID reader that is associated with one or more RFID-tagged personal belongings.

FIG. 2 is a thumbnail sketch of exemplary application software on a mobile device.

FIGS. 3A-C illustrate the steps for registering a RFID-tagged personal belonging to the application software for purposes of tracking.

FIGS. 4A-C illustrate the steps for tracking the user's one or more RFID-tagged personal belongings, which are registered to the application software.

FIG. 5 illustrates, by way of example and not limitation, various possible graphical representations of the labels shown to the user of the application software.

### DETAILED DESCRIPTION OF THE INVENTION

It is understood that specific embodiments are provided as examples to teach the broader inventive concept, and one of ordinary skill in the art can easily apply the teachings of the present disclosure to other methods and systems. Also, it is understood that the methods and systems discussed in the present disclosure include some conventional structures and/or steps. Since these structures and steps are well known in the art, they will only be discussed in a general level of detail. Furthermore, reference numbers are repeated throughout the drawings for the sake of convenience and example, and such repetition does not indicate any required combination of features or steps throughout the drawings.

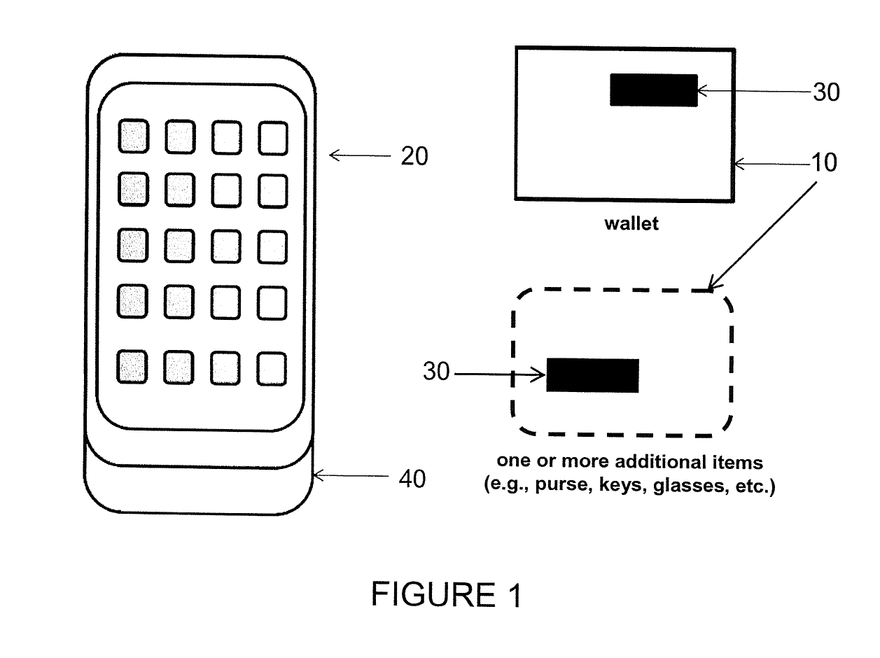

FIG. 1 illustrates an exemplary embodiment of a mobile device 20 with a RFID reader 40 that is associated with one or more RFID-tagged personal belongings 10. The RFID reader 40 is associated with the mobile device 20, which, as discussed above, is well known in the art. While the RFID reader 40 is illustrated as being externally attached to the mobile device 20, the RFID reader 40 may also be incorporated into and/or built-into the mobile device 20 itself. In addition, the RFID reader 40 may include both read and write capabilities.

A user's one or more personal belongings 10 are each attached with an RFID tag 30 to track the one or more personal belongings 10 by the mobile device 20 associated with a RFID reader 40. In addition, each of the user's one or more personal belongings 10 may be attached with the RFID tag 30 by embedding the RFID tag 30 into each of the one or more personal belongings 10. As discussed above, it is well-established in the art to have an RFID tag embedded into the object to be tracked.

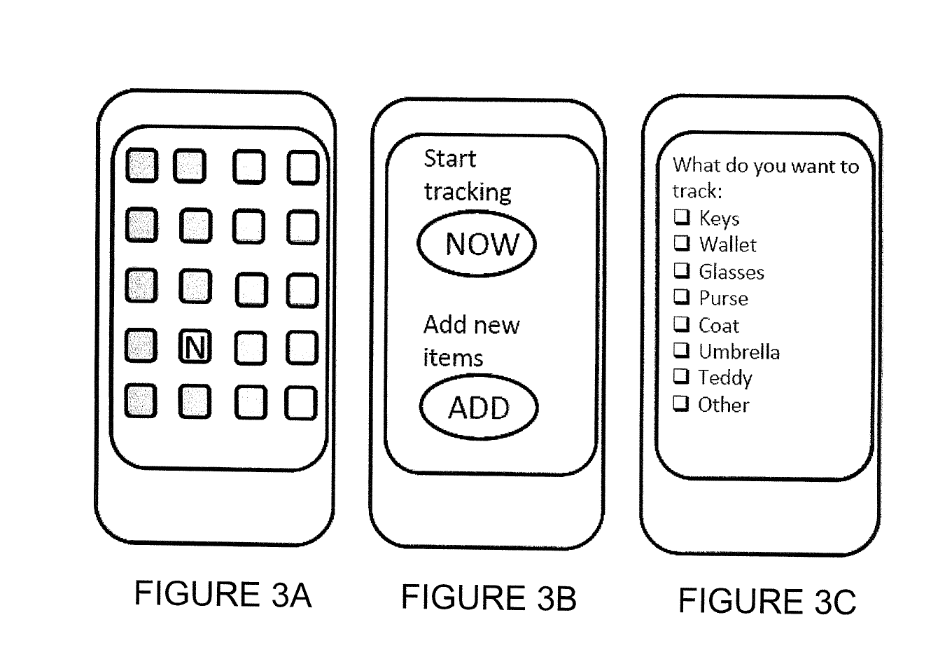

As depicted in FIG. 1, the one or more personal belongings 10 are shown as a wallet and one or more additional items (e.g., purse, keys, glasses, etc.), which is illustrated in dashed lines because the mobile device 20 with a RFID reader 40 tracks one or more personal belongings 10 simultaneously. A user positions the one or more RFID-tagged personal belongings 10 within a range in proximity to the mobile device 20 with the RFID reader 40. Each of the one or more RFID-tagged personal belongings 10 within the range may be registered by the user for purposes of tracking. A more detailed description of the registration process is provided below in relation to the discussion of FIGS. 3A-C.

The range between the personal belongings 10 and the mobile device 20 with the RFID reader 40 is established for the convenience of the user to ensure that his/her personal belongings 10 are not misplaced. As a non-limiting example, the range in proximity to the mobile device 10 may be between two to three feet. Accordingly, the RFID reader 40 with the mobile device 20 tracks the one or more personal belongings 10 associated with the mobile device 20 by detecting whether the one or more personal belongings 10 attached with an RFID tag 30 is outside the range in proximity to the mobile device 20.

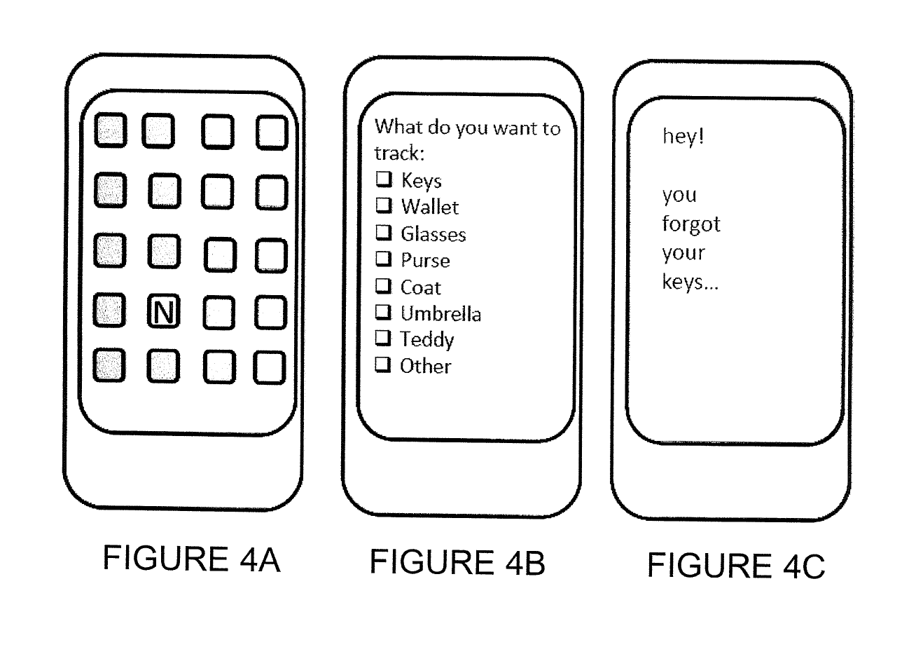

As further detailed below in FIGS. 4A-C, the mobile device 20 provides an alert to the user upon detecting one or more RFID-tagged personal belongings 10 outside the range. In addition, when one of the RFID-tagged personal belongings 10 detected outside the range is brought back within the range the mobile device 20 automatically stops the alert for that specific personal belonging 10. As an alternative, the user is also provided with an employable interface to manually stop the alert.

In addition, the user may be provided with an on/off interface, which is employable to turn on and off the system, and thus stops or starts the tracking of the user's RFID-tagged personal belongings 10.

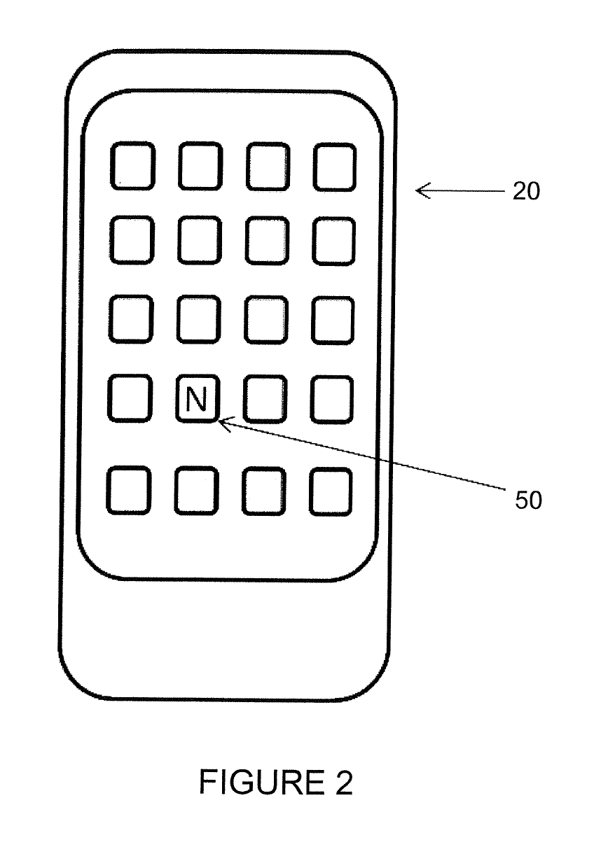

FIG. 2 is a thumbnail sketch of exemplary application software 50 on a mobile device 20. The user installs application software 50 for tracking the one or more personal belongings 10 on his/her mobile device 20. The application software 50 is illustrated running on a mobile operating system, which is running on the mobile device 20. For example, the mobile device 20 may be, but is not limited to, a Smartphone, tablet, personal digital assistant, or other digital mobile device. While FIGS. 1-4 show the mobile device 20 as a Smartphone, the depiction of the invention on a tablet, a personal digital assistant, or other digital mobile device would be the same as illustrated herein.

FIGS. 3A-C illustrate the steps for registering a RFID-tagged personal belonging 10 to the application software 50 for purposes of tracking. The application software 50 registers for tracking the user's one or more RFID-tagged personal belongings 10 by adding each of the RFID-tagged personal belongings 10 to the application software 50. In FIG. 3A, the user activates the application software 50 installed on his/her mobile device 20. As shown in FIG. 3B, the user selects “Add new items” and/or “ADD” to initiate the process of adding new RFID-tagged personal belongings 10 to the application software 50.

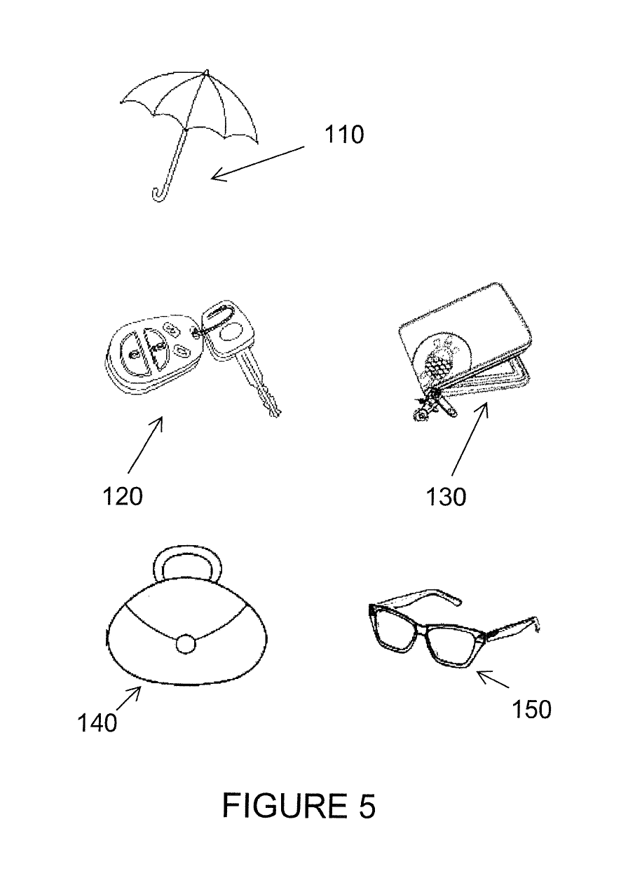

In FIG. 3C, the user positions the RFID-tagged personal belonging 10 desired to be registered within the range in proximity to the mobile device 20. Once the RFID-tagged personal belonging 10 to be registered is within range, the application software 50 assigns a label to describe the RFID-tagged personal belonging 10 being added to the application software 50. For example and not limitation, the label assigned to the RFID-tagged personal belonging 10 may be keys, wallet, glasses, purse, coat, umbrella, teddy, etc. In addition, as illustrated in FIG. 5 and further detailed below, the labels shown to the user may be graphical representations that illustrate the RFID-tagged personal belonging 10 being added to the application software 50. Accordingly, the RFID-tagged personal belonging 10 is registered to the application software 50 for tracking.

FIGS. 4A-C illustrate the steps for tracking the user's one or more RFID-tagged personal belongings 10, which are registered to the application software 50. In FIG. 4A, the user activates the application software 50 installed on his/her mobile device 20 running the mobile operating system. As illustrated above in FIG. 3B, the user may select “Start tracking” and/or “NOW” to initiate the process of tracking registered RFID-tagged personal belongings 10 by the application software 50.

FIG. 4B shows a selection interface employable by the user to select which of the one or more RFID-tagged personal belongings 10 registered to the application software 50 to track. As discussed above, by way of example and not limitation, the labels shown to the user for the RFID-tagged personal belonging 10 may be keys, wallet, glasses, purse, coat, umbrella, teddy, etc. Further, as depicted in FIG. 5 and further described below, the labels shown to the user may be graphical representations that illustrate the RFID-tagged personal belonging 10 registered to the application software 50.

The user may select any combination of registered RFID-tagged personal belongings 10 to be tracked by the system. As discussed above with respect to FIG. 1, the system tracks the RFID-tagged personal belongings 10 by detecting whether each of the one or more RFID-tagged personal belongings 10 registered to the application software 50 is outside the range in proximity to the mobile device 20 with the RFID reader 40.

In FIG. 4C, upon detecting one of the one or more RFID-tagged personal belongings 10 outside the range, the mobile device 20 provides an alert to the user. An alert may be provided for each of one or more RFID-tagged personal belongings 10 detected outside the range. For example, the alert may be, but is not limited to, graphic displays (including images and texts), sounds or vibrations.

FIG. 5 illustrates, by way of example and not limitation, various possible graphical representations of the labels shown to the user of the application software. As discussed above with respect to FIGS. 3C and 4B, the labels describe the user's one or more RFID-tagged personal belongings 10 that are being registered to the application software 50 or being selected for tracking by the application software 50. Labels depicted in FIG. 5 include an umbrella 110, keys 120, a wallet 120, a purse 140, and glasses 150.

Various embodiments disclosed herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to the provided description without departing from the scope or spirit of the disclosure.

Other embodiments, uses and features of the present disclosure will be apparent to those skilled in the art from consideration of the specification and practice of the inventive concepts disclosed herein. The specification and drawings should be considered exemplary only, and the scope of the disclosure is accordingly intended to be limited only by the following claims.

What is claimed is:

1. A system for tracking one or more personal belongings associated with a mobile device comprising:
a radio-frequency identification (RFID) tag attached to each of the one or more personal belongings;
an application software running on a mobile operating system which registers for tracking each of the one or more RFID-tagged personal belongings positioned within a range in proximity to the mobile device and assigns a label to describe each of the one or more RFID-tagged personal belongings registered in the application software; and
a RFID reader associated with the mobile device to track the one or more RFID-tagged personal belongings by detecting whether each of the one or more RFID-tagged personal belongings registered to the application software is outside the range in proximity to the mobile device, and
wherein the mobile device running the mobile operating system provides an alert to a user for each of the one or more RFID-tagged personal belongings when the one or more RFID-tagged personal belongings are detected outside the range.

2. The system according to claim 1, wherein the mobile device stops the alert for one of the one or more RFID-tagged personal belongings when said one of the one or more RFID-tagged personal belongings is within the range.

3. The system according to claim 1, further comprising an alert interface employable by the user to stop the alert.

4. The system according to claim 1, further comprising a selection interface employable by the user to select which of the one or more RFID-tagged personal belongings registered to the application software to track.

5. The system according to claim 1, wherein the mobile device is selected from the group consisting of Smartphone, tablet, and personal digital assistant.

6. The system according to claim 1, wherein the range in proximity to the mobile device is between two to three feet.

7. The system according to claim 1, wherein the alert is selected from the group consisting of graphic displays, sounds, and vibrations.

8. The system according to claim 1, wherein the label assigned to each of the one or more personal belongings is selected from the group consisting of keys, wallet, glasses, purse, coat, umbrella and teddy.

9. The system according to claim 1, wherein the RFID reader includes read and write capabilities.

10. The system according to claim 1, further comprising an on/off interface employable by the user to turn on and off the system.

11. The system according to claim 11, wherein the RFID tag is embedded into at least one of said one or more personal belongings.

12. A method for tracking one or more personal belongings associated with a mobile device with a RFID reader comprising:
installing an application software for tracking the one or more personal belongings on the mobile device with the RFID reader;
attaching a RFID tag to each of the one or more personal belongings;
positioning each of the one or more RFID-tagged personal belongings within a range in proximity to the mobile device with the RFID reader;
assigning a label to describe each of the one or more RFID-tagged personal belongings;
registering each of the one or more RFID-tagged personal belongings to the application software for tracking;
tracking the one or more RFID-tagged personal belongings registered to the application software;
detecting whether each of the one or more RFID-tagged personal belongings registered to the application software is outside the range in proximity to the mobile device with the RFID reader; and
providing an alert to a user for each of the one or more RFID-tagged personal belongings when the one or more personal belongings are detected outside the range.

13. The method according to claim 12, further comprising stopping the alert for one of the one or more RFID-tagged personal belongings when said one of the one or more RFID-tagged personal belongings is within the range.

14. The method according to claim 12, further comprising stopping the alert by the user.

15. The method according to claim 12, further comprising selecting by the user which of the registered one or more RFID-tagged personal belongings to track.

16. The method according to claim 12, wherein the mobile device is selected from the group consisting of Smartphone, tablet, and personal digital assistant.

17. The method according to claim 12, wherein the range in proximity to the mobile device is between two to three feet.

18. The method according to claim 12, wherein the alert is selected from the group consisting of graphic displays, sounds, and vibrations.

19. The method according to claim 12, wherein the label assigned to each of the one or more personal belongings is selected from the group consisting of keys, wallet, glasses, purse, coat, umbrella, and teddy.

20. The method according to claim 12, wherein the RFID reader includes read and write capabilities.

21. The method according to claim 12, further comprising turning on and off the application software by the user.

22. The method according to claim 12, wherein the RFID tag is embedded into at least one of said one or more personal belongings.
